(19) United States
(12) Patent Application Publication
(10) Pub. No.: US 2025/0318637 A1
(43) Pub. Date: Oct. 16, 2025

(54) PORTABLE WORKSTATION

(71) Applicant: Chevis Moguls LLC, Palmdale, CA (US)

(72) Inventor: Raymond Charles Chevis, JR., Palmdale, CA (US)

(21) Appl. No.: 19/056,169

(22) Filed: Feb. 18, 2025

Related U.S. Application Data
(63) Continuation of application No. 17/710,546, filed on Mar. 31, 2022, now abandoned.
(60) Provisional application No. 63/169,569, filed on Apr. 1, 2021.

(51) Int. Cl. A47B 21/03; G06F 1/26

(52) U.S. Cl. CPC A47B 21/0314; G06F 1/26; A47B 2021/0321

(57) ABSTRACT

A portable workstation. The portable workstation comprises a housing having a top wall, a bottom wall, sidewalls, an open end, and a closed end, where the top wall comprises a cut-out portion. A digital display is rotatably coupled to the top wall of the housing by a support arm, where the digital display is rotatable between a first position and a second position. In the first position, the digital display is disposed in the cut-out of the top wall such that the housing and digital display define a hollowed enclosure for storing computer accessories therein. In the second position, the digital display is removed from the cut-out and retained in a substantially upright orientation. The workstation may further include a detachable carrying strap for toting the workstation, where the strap is configured to be worn over a user's shoulder.

### CROSS-REFERENCE TO RELATED APPLICATIONS

This application is a continuation of U.S. patent application Ser. No. 17/710,546, filed Mar. 31, 2022, which claims the benefit of priority under 35 U.S.C. § 119 (e) from U.S. Provisional Application No. 63/169,569, filed Apr. 1, 2021, both of which are hereby incorporated by reference in their entireties for all purposes.

### TECHNICAL FIELD

The present disclosure generally relates to computer workstations and, in particular, to portable workstations for mobile devices that also serve as carrying cases.

### BACKGROUND

Toting mobile devices and, in particular, lap top computers and their accessories can be cumbersome, especially for persons who work in the field. In carrying these devices, persons may have to carry a computer, an electrical power cord, and in some instances, a keyboard, a computer mouse, a mouse pad, stationary, such as a notepad, pens and pencils, and an electrical charger for their mobile device. Existing computer cases are useful, but can often be too bulky, depending on the number of accessories the user needs to carry. Further, for persons who work in the field, sources for powering mobile devices can be limited.

A need therefore exists for a compact means for toting and powering mobile devices.

### SUMMARY

The present disclosure provides an all-in-one portable computer workstation and carrying case with a removable carrying strap. The portable workstation comprises a housing having a top wall, a bottom wall, sidewalls, an open end, and a closed end, where the top wall comprises a cut-out portion. A digital display is rotatably coupled to the top wall of the housing by a support arm, where the digital display is rotatable between a first position and a second position. In the first position, the digital display is disposed in the cut-out of the top wall such that the housing and digital display define a hollowed enclosure for storing computer accessories therein. In the second position, the digital display is removed from the cut-out and retained in a substantially upright orientation to allow a user to view content displayed on the digital display. The workstation may further include a detachable carrying strap for toting the workstation, where the strap is configured to be worn over a user's shoulder.

The present disclosure further provides a portable workstation comprising a housing having a top wall, a bottom wall, sidewalls, an open end, and a closed end, where the top wall comprises a cut-out portion. A digital display is rotatably coupled to the top wall of the housing by a support arm, where the digital display is rotatable between a first position and a second position. In the first position, the digital display is disposed in the cut-out of the top wall such that the housing and digital display define a hollowed enclosure for storing computer accessories therein. In the second position, the digital display is removed from the cut-out and retained in a substantially upright orientation to allow a user to view content displayed on the digital display.

The workstation further includes a processor communicatively coupled to the digital display, where the processor is disposed in the enclosure. A power supply is electronically coupled to the digital display and the processor, where the power supply is disposed in the enclosure. A keyboard is communicatively coupled to the processor, where the keyboard is disposed in the enclosure, and where the processor is configured to receive commands from the keyboard.

The disclosure herein is a summary of the invention and not an extensive overview of all contemplated embodiments. It should be appreciated that many other features, applications, embodiments, implementations and/or variations of the disclosed technology will be apparent from the accompanying drawings and from the following detailed description. While multiple implementations are disclosed, the drawings and detailed description are to be regarded as illustrative in nature and not restrictive.

### BRIEF DESCRIPTION OF THE DRAWINGS

This disclosure may be better understood by referring to the following figures. The components in the figures are not necessarily to scale, emphasis instead being placed upon illustrating the principles of the disclosure. In the figures, the reference numerals designate corresponding parts throughout the different views.

FIG. 1 is a perspective view of a portable workstation according to the teaching of the present disclosure, the digital display in an upright positon.

FIG. 2 is an exploded view of the portable workstation of FIG. 1.

FIG. 3 is an exploded view of bottom wall of the portable workstation of FIG. 1.

FIG. 4 is an exploded view of top wall of the portable workstation of FIG. 1.

FIG. 5 is another exploded view of top wall of the portable workstation of FIG. 1.

FIG. 6 perspective view the portable workstation of FIG. 1 with the digital display in a stored positon.

### DETAILED DESCRIPTION

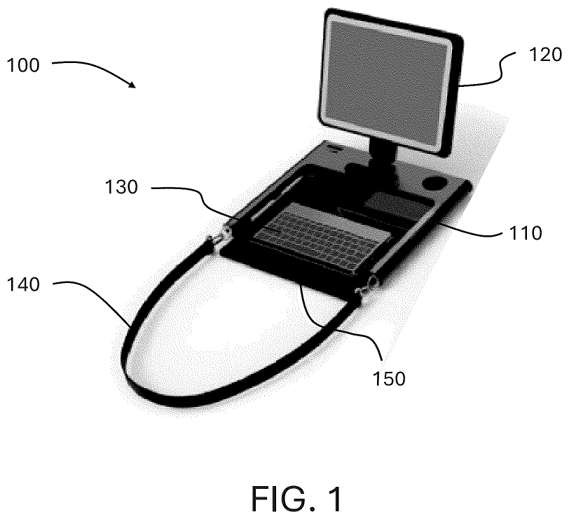

FIGS. 1-6 illustrate examples of various implementations of a portable workstation. As described herein, the workstation includes a housing having a top wall, a bottom wall, sidewalls, an open end, and a closed end, where the top wall comprises a cut-out portion. A digital display is rotatably coupled to the top wall of the housing by a support arm, where the digital display is rotatable between a first position and a second position. In the first position, the digital display is disposed in the cut-out of the top wall such that the housing and digital display define a hollowed enclosure for storing computer accessories therein. In the second position, the digital display is removed from the cut-out and retained in a substantially upright orientation so content displayed on the digital display may be viewed by the user.

FIG. 1 is a perspective view of a portable workstation 100 according to the teachings of the present disclosure. As shown, the workstation 100 may include a hollowed housing 110, a digital display 120 rotatably coupled to the housing 110, and a keyboard 130 which may be stored in the 110. The housing 110, framing of the digital display 120, and the keyboard 130 may be made from the same or any combination of materials. In some implementations, the workstation may include a carrying strap 140 coupled to opposing sides of the housing 110, as described in more detail below.

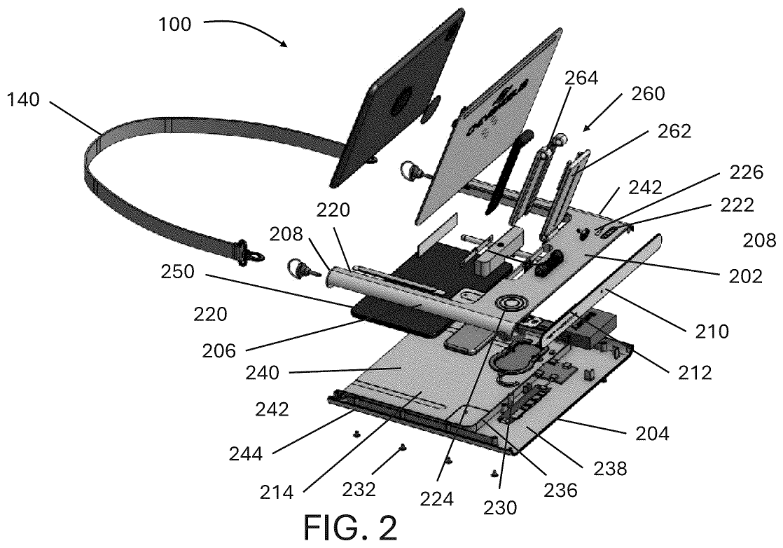

FIG. 2 is an exploded view of the workstation 100. As shown, the housing 110 includes a top wall 202, a bottom wall 204, sidewalls 206, an open end 208, and a closed end 210 defined by an end plate 212. The top wall 202, bottom wall 204, sidewalls 206, and closed end 210 define an enclosure 214 for storing a worktable 250, the keyboard 130, and other items. The top wall 202, bottom wall 204, sidewalls 206, and end plate 212 may be made of the same or different complimentary materials such as plastic, stainless steel, carbon, aluminum, Kevlar, ceramic, tempered glass, polyvinyl chloride (PVC), or any other suitable material.

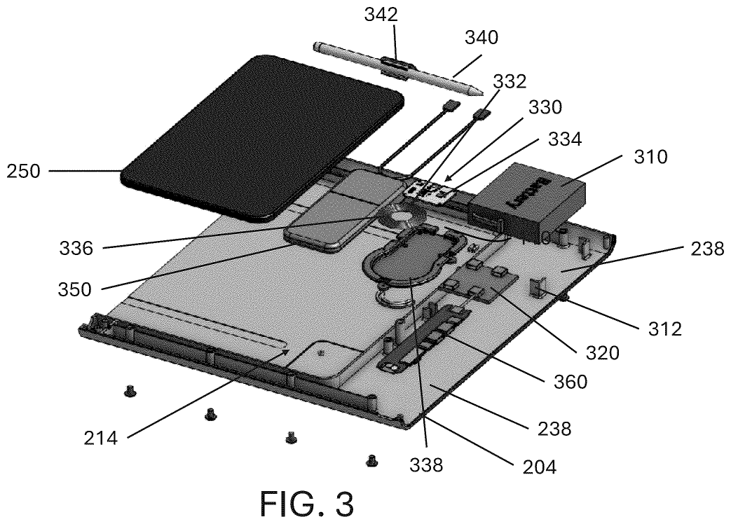

The top wall 202 may comprise a thin planar sheet of material having a cut-out 220. The cut-out 220 is configured to receive the digital display 120 when the display is moved to a stored position. In some implementations, the top wall 202 may also include one or more universal serial bus (USB) ports 222 for connecting to and powering peripheral electrical devices from the workstation 100. The top wall 202 may further include a circular-shaped sink 224 for storing a cup or other items. Moreover, the top wall 202 may include a charging indicator lamp 226 to alert the user that power supply 310 (see FIG. 3) needs to be charged once its power reaches below a certain percentage of its battery power capacity, for example, below 20% of its power capacity.

The bottom wall 204 may comprise a planar sheet of material. The bottom wall 204 may include one or more circular spacers 230 having threaded holes extending therethrough. The spacers are adapted to receive fasteners 232 used to fasten the top wall 202 to the bottom wall 204.

The bottom wall 204 may further include a frame 236 configured to secure the worktable 250 to the bottom wall 204 in the enclosure 214. The frame 236 may be coupled or glued to, or otherwise integrally formed with the interior surface 238 of the bottom wall 204. When secured to frame 234, the worktable 250 and the interior surface 238 form a pocket 240 for storing the keyboard 130 (see FIG. 1).

The bottom wall 204 may further include a frame 236 configured to secure the worktable 250 to the bottom wall 204 in the enclosure 214. The frame 236 may be coupled or glued to, or integrally formed with the interior surface 238 of the bottom wall 204. When secured to frame 234, the worktable 250 and the interior surface 238 form a pocket 240 for storing the keyboard 130.

In some implementations, the bottom wall 204 may further include a pair of grooves 242 extending substantially along the length of the interior surface 238 of the bottom wall 204. The grooves 242 are adapted to receive the wheels of a carriage (not shown) used to extend or slide the keyboard 130 out from the pocket 240 when the user desires to use the keyboard or retract or slide the keyboard 130 into the pocket 240 when the user desires to store the keyboard in the housing.

In the present example, the sidewalls 206 may be formed by coupling contoured side portions of the top wall 242 together with contoured side portions of the bottom wall 244. As shown, the contoured side portions 242 and 244 are curved but, in other implementations, the contoured side portions 242 and 244 may be chamfered or comprise any other suitable geometric profile. The contoured side portions 242 and 244 may be glued, bonded, or otherwise integrally formed with outer edges of the top wall 202 and bottom wall 204, respectively. In the example shown, the contoured side portions 242 and 244 are coupled together by threaded fasteners.

In other implementations, the sidewalls 206 may an elongated thin planar sheet of material coupled to the outer edges of the top wall 202 and bottom wall 204.

The end plate 212 may comprise an elongated thin planar sheet of material. The end plate 212 may be attached to the closed end 210 of the top wall 202 and bottom wall 204 by glue, bonding, welding, fasteners, or any other suitable means. In the present example, the end plate 212 may be bonded to the closed end of the bottom wall 204.

FIG. 3 is an exploded view of the bottom wall assembly of the workstation 100. As shown, additional components of the workstation 100 may be housed within the enclosure 214. Namely, the enclosure 214 may house a power supply 310 electrically coupled to one or more electrical circuits 320, a wireless charging station 330, and the worktable 250.

The power supply 310 may be coupled to the bottom wall 204 by one or more L-shaped brackets 312 affixed to the interior surface 238 of the bottom wall 204. The L-shaped brackets 312 may be coupled or glued to, or otherwise integrally formed with the interior surface 238. The L-shaped brackets 312 are adapted and oriented to engage and secure the power supply 310 by, for example, a press fit, thus permitting the power supply 310 to be replaced.

The power supply 310 may be electrically coupled to various components of the workstation 100 to provide electrical power thereto, including, but not limited to, the electrical circuit 320, the wireless charging station 330, the digital display 120, and the usb port 222 (FIG. 2). The power supply 310 may comprise an alkaline battery, a dry-cell battery, a rechargeable lithium-ion battery, or any other suitable power source. In some implementations, the power supply 310 may be powered by an electric cable (not shown).

As mentioned, the power supply 310 may be electrically coupled to one or more electrical circuits 320. The electrical circuits 320 may comprise printed circuit boards affixed to the interior surface 238 of the bottom wall 204. The basic designs and components of various types of printed circuit boards are well-known and, therefore, need not be described in detail.

The electrical circuits 320 may be electrically coupled to various components of the workstation 100 to provide electrical power and signals thereto.

As further shown, the charging station 330 may include a coil pad 332 electrically coupled to an electrical circuit 334. The coil pad 332 may comprise an induction coil 336 for generating a communication electromagnetic field to transmit and/or receive wireless signals and electromagnetic energy, through inductive coupling or charging, to an electrical device, such as a mobile phone 350, positioned in close proximity to the induction coil 336. In some implementations, the charging station 330 may include a USB-C interface and may be compatible with QC 18 W and PD 18 W standards. The electrical circuit 334 may comprise a printed circuit board affixed to the interior surface 238 of the bottom wall 204. The charging station 330 may be configured to power mobile phones with wireless charging capabilities and may offer a rated output power of about 15 W-25 W.

In some implementations, the coil pad 332 and electrical circuit 334 may be secured to the interior surface 238 by carriage 338. The coil pad 332 and electrical circuit 334 may be secured to carriage 338 by fasteners, bonding, glue, snap fit, or any other suitable means.

The carriage 338 may be secured to the interior surface 238 by fasteners, bonding, glue, or any other suitable means. The carriage 338 may be made from plastic, rubber, PVC, ceramic, aluminum, stainless steel, or any other suitable material.

In the implementation shown, the coil pad 332 and electrical circuit 334 may be secured to the interior surface 238 of the bottom wall 204 within the pocket 240 of the enclosure 214. Framing 236 may be bonded, glued, or integrally formed with the interior surface 238 of the bottom wall 204 to form an outer perimeter of the pocket 240. The worktable 250 may be secured to the top of the framing 236 to form a top wall of the pocket. The worktable 250 may be secured to the top of the framing 236 by bonding, glue, fasteners, or any other suitable means. Thus, the framing 236, interior surface 238, and worktable 250 define the pocket 240 that houses the various components of the charging station 330, as well as the keyboard 140 (see FIG. 1).

The worktable 250 may comprise a thin planar sheet of material having outer dimensions corresponding with the dimensions of the framing 236. The worktable 250 may be made of glass, fiberglass, plastic, polycarbonate, metal, ferrite, foil, or any other electromagnetic conducting material. In preferred implementations, a mobile device, such as mobile phone 350, may be powered or otherwise recharged by electromagnetic induction by placing the device on the worktable 250 in proximity to the charging station 330.

In other implementations, stationary 340, such as a pen or pencil, or a computer mouse (not shown) may be housed in the enclosure 214. In the example shown, the stationary 340 is secured within the enclosure 214 by a clip 342 secured to an internal surface of the sidewalls 206.

Turning back to FIG. 2, the digital display 120 may be rotatably coupled to the top wall 202 by a support arm 260. The support arm 260 may include a first support member 262 and a second support member 264. The first support member 262 and the second support member 264 may be constructed from materials such as plastic, stainless steel, carbon, aluminum, ceramic, PVC, or any other suitable material.

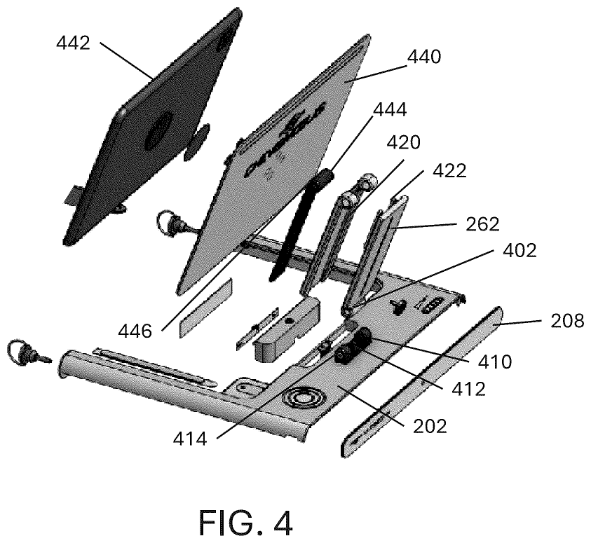

As better shown in FIG. 4, the first support member 262 may comprise a thin elongated plate with a collar 402 coupled to an end of the member. The collar 402 is configured to fit within a seat 412 formed by a U-shaped bracket 410 affixed to the top wall 202. The bracket 410 may be affixed to the top wall 202 by bonding, glue, welding, fasteners, or any other suitable means.

The collar 402 may be configured to dimensions permitting the collar 402 to rotate both clockwise and counterclockwise within seat 412. A collar pin (not shown) coupled to the seat 410 may extend through the collar 402 to rotatably couple the first support member 262 to the top wall 202 about a pivot 414.

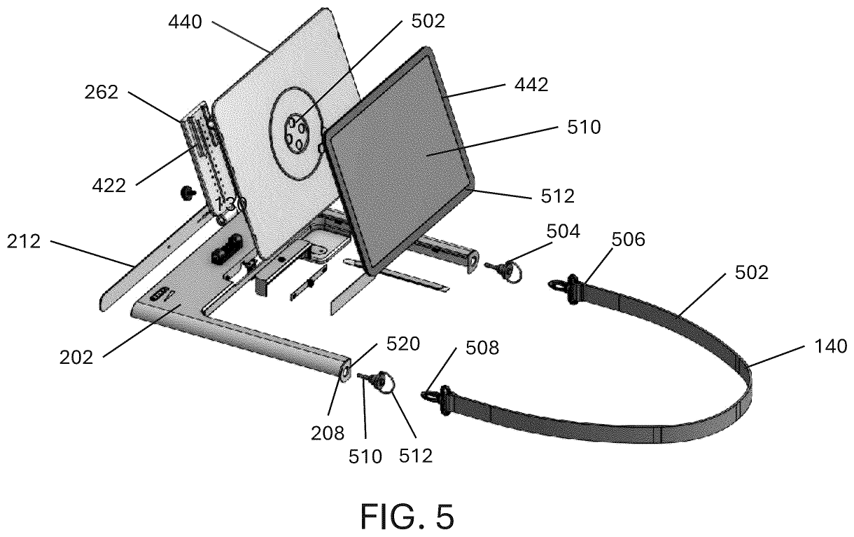

The second support member 264 may comprise a thin elongated plate with a shape and dimensions corresponding to the shape and dimensions of the first support member 262. The second support member 264 may include a set of guides 420 that engage a set of rails 422 (see also FIG. 5) coupled to the first support member 262, such that the second support member 264 is slidably coupled to the first support member 262. This permits the height of the digital display 120 to be adjusted relative to the top wall 202, as discussed in further detail below.

The digital display 120 may comprise a support plate 440 and a display panel 442. The support plate 440 may be constructed from a thin, substantially rectangular planar sheet of material. The support plate 440 may be made from plastic, stainless steel, carbon, aluminum, ceramic, PVC, or any other suitable material. The support plate 440 may include a bracket 502 having threaded holes for receiving threaded fasteners used to secure the display panel 442 to the support plate 440. The support plate 440 may have perimeter dimensions corresponding to the perimeter dimensions of the display panel 442.

The support plate 440 may further include a support bracket 444 configured to couple the second support member 264 of the support arm 260. The support bracket 444 may include a thin, slender sheet of material having a collar 446 at one end. The collar 446 may be configured to be removably coupled a pair of grommets 430 formed at an end of the support member 264 via, for example, a collar pin or any other suitable means.

As better shown in FIG. 5, the digital display 120 may comprise a screen 510 and a display housing 512. The screen 510 may comprise a liquid crystal screen for displaying visual images and content. In some implementation, the dimensions of the screen 510 may be, for example, 11 inches, 12 inches, or any other suitable dimensions. In some implementation, the screen 510 may have a pixel resolution of 1366×768, 1920×1080, 3840×2160, or any other suitable resolution. In some implementations, the screen 510 may be a touch screen having multi-touch capabilities. The display housing 512 may be constructed to any desired thickness and made from plastic, stainless steel, carbon, aluminum, ceramic, PVC, or any other suitable material.

The display panel 120 may be electronically coupled to a central processing unit (CPU) 360 (see FIG. 3) having a processing circuit, random-access memory, a bus interface, and a hard drive. The various components of central processing units are well-know and therefore need not be described in detail. The CPU 360 may be electronically coupled to the keyboard 130 by a wired or wireless (e.g., Bluetooth®) connection to transmit input commands from the keyboard 130 to the CPU 360. The CPU 360 may further include a modem (not shown) for facilitating an Internet connection to the world wide web.

Referring now to FIG. 5, the carrying strap 140 may include a strap 502 having anchors 504 detachably coupled to the strap 140 at its ends 506. The strap 502 may comprise a thin strip of material made from canvas, nylon, polyester, polypropylene, leather, or any other suitable material. The strap 502 may include clips 508 at its opposing ends 506 for attaching to the anchor 504.

The anchor 502 may include a plug 510 on one end and a ring 512 on an opposite end. In the example shown, the plug 510 is configured to be retained in orifices 520 formed in an open end of the top wall 202. However, in other implementations, the anchor 502 may be secured to the top wall 202 by gluing, bonding, welding, or any other suitable means.

The ring 512 may be rotatably coupled to the plug 510. The ring 512 defines a latch for engaging the clips 510. The clips 510 are configured to engage the rings 512 when the carrying strap 140 is assembled to tote the workstation, for example, on the user's shoulders, or disengage the rings 512 when the user wishes to disassemble the carrying strap 140.

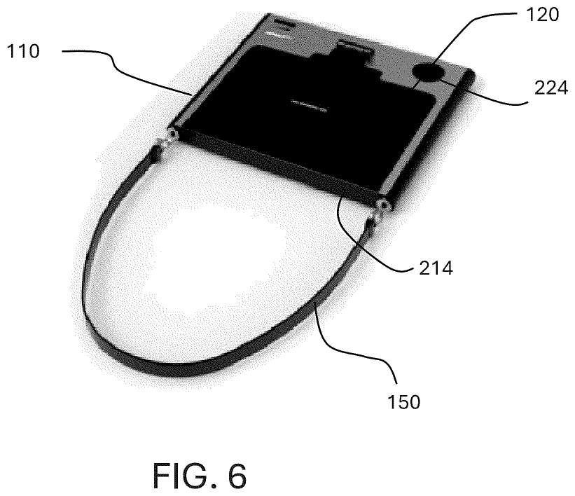

In use, the digital display 120 may be rotatable between a first (stored) position, as shown in FIG. 6, and a second (upright) position, as shown in FIG. 1.

In the first position, the digital display 120 is stored within the cut-out 220 of the top wall 202. In the first position, the digital display 120, together with the housing 110 define the enclosure 214 that stores the keyboard 130 and other computer accessories.

In the second position, the display panel 120 is rotated away from the to wall 202 and positioned substantially upright. In the second position, the user is able to view content and images displayed on the digital display 120. In the second position, the user is also able to access the keyboard 130 and other computer accessories stored in the enclosure 214. In this way, the workstation 100 functions as a modular laptop computer and a carrying case. The workstation may be compatible with Apple and Android mobile devices, as the CPU 360 may run both iOS and Andriod mobile operating system software.

In the second position, the height of the digital display 120 relative to the top wall 202 may be adjusted by sliding the display 120 screen up or down. The first and second support members 262 and 264 may include a locking mechanism to secure the digital display 120 at a desired height. In some implementations, the support arm 260 may be spring-loaded to urge the digital display 120 toward the stored position. In other implementations, the support arm 260 may be manually adjusted to retain digital display 120 in various orientations between the first position and the second position.

In some implementations, the workstation 100 may further include a removable panel 150 (FIG. 1) configured to be detachably attached to the open end 208 of the enclosure 214 to enclose the hollowed enclosure. In some implementations, the removable panel 150 may be completely detachable from the open end 208. In other implementations, an edge of the removable panel 150 may be coupled to the bottom wall 204 so the removable panel 150 may be rotated open and closed like a flap.

Referring back to FIG. 1, the workstation 100 further includes keyboard 130. The keyboard 130 serves as an input device to provide textual input into CPU and to control the operation of the device. The keyboard 130 may be a generally rectangular standard 104-key alphanumeric keyboard. The keyboard 130 may be electrically coupled to the CPU 360 via a hard-wired or wireless (e.g., Bluetooth®) connection. The keyboard 130 may be stored in the pocket 240 (see FIG. 2) when not in use. In some implementations, the keyboard may be slidably coupled to the interior surface of the bottom wall, wherein the keyboard is configured to slide along grooves 242 (see FIG. 2) between a retracted position and a stored position. In the retracted position, the keyboard 130 is removed from the pocket 240 so it can be accessed and engaged by the user. During storage, the keyboard 130 may be translated to its stored position inside of the pocket 240.

The present disclosure provides an all-in-one mobile computer workstation and carrying case with a removable carrying strap. While the present disclosure is described with a computer having a CPU and display panel, the present disclosure may also apply to a tablet or other mobile device.

In general, terms such as “coupled to,” and “configured for coupling to,” and “secured to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

Although the previous description illustrates particular examples of various implementations, the present disclosure is not limited to the foregoing illustrative examples. A person skilled in the art is aware that the disclosure as defined by the appended claims and their equivalents can be applied in various further implementations and modifications. In particular, a combination of the various features of the described implementations is possible, as far as these features are not in contradiction with each other. Accordingly, the foregoing description of implementations has been presented for purposes of illustration and description. Modifications and variations are possible in light of the above description.

What is claimed is:

1. A portable workstation comprising:
a housing having a top wall, a bottom wall, sidewalls, an open end, and a closed end, wherein the top wall comprises a cut-out portion; and
a digital display rotatably coupled to the top wall of the housing by a support arm,
wherein the digital display is rotatable between a first position and a second position,
wherein, in the first position, the digital display is disposed in the cut-out of the top wall such that the housing and digital display define a hollowed enclosure for storing computer accessories therein, and
wherein, in the second position, the digital display is removed from the cut-out and retained in a substantially upright orientation to allow a user to view content displayed on the digital display.

2. The portable workstation of claim 1, further comprising a central processing unit electronically coupled to the digital display and an input device electronically coupled to the central processing unit, wherein the central processing unit and the input device are stored in the enclosure.

3. The portable workstation of claim 1, further comprising a wireless charging station disposed in the enclosure, wherein the wireless charging station is configured to power one or more mobile devices by inductive charging.

4. The portable workstation of claim 1, further comprising a carrying strap detachably coupled to the housing for toting the portable workstation, wherein the carrying strap is configured to be worn over a user's shoulder.

5. A portable workstation comprising:
a housing having a top wall, a bottom wall, sidewalls, an open end, and a closed end, wherein the top wall comprises a cut-out portion;
a digital display rotatably coupled to the top wall of the housing by a support arm,
wherein the digital display is rotatable between a first position and a second position,
wherein, in the first position, the digital display is disposed in the cut-out of the top wall such that the housing and digital display define a hollowed enclosure for storing computer accessories therein, and
wherein, in the second position, the digital display is removed from the cut-out and retained in a substantially upright orientation;
a processor communicatively coupled to the digital display, wherein the processor is disposed in the enclosure;
a power supply electronically coupled to the digital display and the processor, wherein the power supply is disposed in the enclosure; and
a keyboard communicatively coupled to the processor, wherein the keyboard is disposed in the enclosure, and wherein the processor is configured to receive commands from the keyboard.

6. The portable workstation of claim 5, further comprising a wireless charging station disposed in the enclosure, wherein the wireless charging station is configured to power one or more mobile devices by inductive charging.

7. The portable workstation of claim 5, further comprising a carrying strap detachably coupled to the housing for toting the portable workstation, wherein the carrying strap is configured to be worn over a user's shoulder.
